(19) United States
(12) Patent Application Publication
(10) Pub. No.: US 2014/0307365 A1
(43) Pub. Date: Oct. 16, 2014

(54) SOLID ELECTROLYTIC CAPACITOR PACKAGE STRUCTURE FOR DECREASING EQUIVALENT SERIES RESISTANCE AND METHOD OF MANUFACTURING THE SAME

(71) Applicant: APAQ TECHNOLOGY CO., LTD., Miaoli County (TW)

(72) Inventors: CHI-HAO CHIU, HSINCHU CITY (TW); CHING-FENG LIN, HSINCHU COUNTY (TW); KUN-HUANG CHANG, HSINCHU CITY (TW); CHUN-CHIA HUANG, TAINAN COUNTY (TW)

(73) Assignee: APAQ TECHNOLOGY CO., LTD., Miaoli County (TW)

(21) Appl. No.: 13/860,602

(22) Filed: Apr. 11, 2013

(51) Int. Cl. H01G 9/15; H01G 9/00

(52) U.S. Cl. CPC H01G 9/15; H01G 9/0029
USPC 361/524; 361/541; 29/25.03; 29/17.3

(57) ABSTRACT

A solid electrolytic capacitor package structure for decreasing equivalent series resistance (ESR), includes a capacitor unit, a package unit and a conductive unit. The capacitor unit includes a plurality of first stacked-type capacitors sequentially stacked on top of one another and electrically connected with each other. The package unit includes a package body for enclosing the capacitor unit. The conductive unit includes a first conductive terminal and a second conductive terminal having a through hole, and the stacked-type capacitors are electrically connected between the first and the second conductive terminals. The bottommost first stacked-type capacitor is positioned on the top surface of the second conductive terminal through conductive paste that has a first conductive portion disposed between the bottommost first stacked-type capacitors and the top surface of the second conductive terminal and a second conductive portion filling in the through groove to connect with the first conductive portion.

### BACKGROUND OF THE INVENTION

1. Field of the Invention

The instant disclosure relates to a solid electrolytic capacitor package structure and a method of manufacturing the same, and more particularly to a solid electrolytic capacitor package structure for decreasing equivalent series resistance and a method of manufacturing the same.

2. Description of Related Art

Various applications of capacitors include home appliances, computer motherboards and peripherals, power supplies, communication products and automobiles. The capacitors such as solid electrolytic capacitors are mainly used to provide filtering, bypassing, rectifying, coupling, blocking or transforming function. Because the solid electrolytic capacitor has the advantages of small size, large electrical capacity and good frequency characteristic, it can be used as a decoupling element in the power circuit of a central processing unit (CPU). In general, a plurality of capacitor elements is stacked together to form a stacked solid electrolytic capacitor with a high electrical capacity. In addition, the stacked solid electrolytic capacitor of the prior art includes a plurality of capacitor elements and a lead frame. Each capacitor element includes an anode part, a cathode part and an insulating part. The insulating part is insulated from the anode part and the cathode part. More specifically, the cathode parts of the capacitor elements are stacked on top of one another.

### SUMMARY OF THE INVENTION

One aspect of the instant disclosure relates to a solid electrolytic capacitor package structure for decreasing equivalent series resistance and a method of manufacturing the same.

One of the embodiments of the instant disclosure provides a solid electrolytic capacitor package structure for decreasing equivalent series resistance, comprising: a capacitor unit, a package unit and a conductive unit. The capacitor unit includes a plurality of first stacked-type capacitors sequentially stacked on top of one another and electrically connected with each other, wherein each first stacked-type capacitor has a first positive electrode portion and a first negative electrode portion. The package unit includes a package body for enclosing the capacitor unit. The conductive unit includes a first conductive terminal and a second conductive terminal separated from the first conductive terminal, wherein the first conductive terminal has a first embedded portion electrically connected to the first positive electrode portion of the first stacked-type capacitor and enclosed by the package body and a first exposed portion connected with the first embedded portion and exposed from the package body, and the second conductive terminal has a second embedded portion electrically connected to the first negative electrode portion of the first stacked-type capacitor and enclosed by the package body and a second exposed portion connected with the second embedded portion and exposed from the package body. More precisely, the second conductive terminal has a top surface, a bottom surface corresponding to the top surface, and at least one through hole connected between the top surface and the bottom surface, the bottommost first stacked-type capacitor is positioned on the top surface of the second conductive terminal through conductive paste, and the conductive paste has a first conductive portion disposed between the bottommost first stacked-type capacitor and the top surface of the second conductive terminal and a second conductive portion filling in the at least one through hole to connect with the first conductive portion.

Another one of the embodiments of the instant disclosure provides a solid electrolytic capacitor package structure for decreasing equivalent series resistance, comprising: a capacitor unit, a package unit and a conductive unit. The capacitor unit includes a plurality of first stacked-type capacitors sequentially stacked on top of one another and electrically connected with each other, wherein each first stacked-type capacitor has a first positive electrode portion and a first negative electrode portion. The package unit includes a package body for enclosing the capacitor unit. The conductive unit includes a first conductive terminal and a second conductive terminal separated from the first conductive terminal, wherein the first conductive terminal has a first embedded portion electrically connected to the first positive electrode portion of the first stacked-type capacitor and enclosed by the package body and a first exposed portion connected with the first embedded portion and exposed from the package body, and the second conductive terminal has a second embedded portion electrically connected to the first negative electrode portion of the first stacked-type capacitor and enclosed by the package body and a second exposed portion connected with the second embedded portion and exposed from the package body. More precisely, the second conductive terminal has a top surface, a bottom surface corresponding to the top surface, a lateral surface connected between the top surface and the bottom surface, and at least one through groove connected among the top surface, the bottom surface and the lateral surface, the bottommost first stacked-type capacitor is positioned on the top surface of the second conductive terminal through conductive paste, and the conductive paste has a first conductive portion disposed between the bottommost first stacked-type capacitor and the top surface of the second conductive terminal and a second conductive portion filling in the at least one through groove to connect with the first conductive portion.

Yet another one of the embodiments of the instant disclosure provides a method of manufacturing a solid electrolytic capacitor package structure for decreasing equivalent series resistance, comprising: providing a first conductive terminal and a second conductive terminal separated from the first conductive terminal, wherein the second conductive terminal has a top surface, a bottom surface corresponding to the top surface, and at least one through hole connected between the top surface and the bottom surface; placing a plurality of first stacked-type capacitors on the top surface of the second conductive terminal, wherein the first stacked-type capacitors are sequentially stacked on top of one another and electrically connected with each other, each first stacked-type capacitor has a first positive electrode portion and a first negative electrode portion, the bottommost first stacked-type capacitor is positioned on the top surface of the second conductive terminal through conductive paste, and the conductive paste has a first conductive portion disposed between the bottommost first stacked-type capacitor and the top surface of the second conductive terminal and a second conductive portion filling in the at least one through hole to connect with the first conductive portion; forming a package body to enclose the first stacked-type capacitors, wherein the first conductive terminal has a first embedded portion electrically connected to the first positive electrode portion of the first stacked-type capacitor and enclosed by the package body and a first exposed portion connected with the first embedded portion and exposed from the package body, and the second conductive terminal has a second embedded portion electrically connected to the first negative electrode portion of the first stacked-type capacitor and enclosed by the package body and a second exposed portion connected with the second embedded portion and exposed from the package body; and then bending the first exposed portion and the second exposed portion along an outer surface of the package body.

More precisely, each first stacked-type capacitor includes a valve metal foil, an oxide insulation layer enclosing the valve metal foil, a conductive polymer layer covering one portion of the oxide insulation layer, a carbon paste layer covering the conductive polymer layer, and a silver paste layer covering the carbon paste layer, wherein each first stacked-type capacitor has a surrounding insulating layer disposed on the outer surface of the oxide insulation layer and around the outer surface of the oxide insulation layer, and the lengths of the conductive polymer layer, the carbon paste layer and the silver paste layer of each first stacked-type capacitor are limited by the corresponding surrounding insulating layer. The oxide insulation layer has a surrounding region formed on the outer surface thereof, and the surrounding insulating layer of each first stacked-type capacitor is surroundingly disposed on the surrounding region of the corresponding oxide insulation layer and contacting an end of the corresponding conductive polymer layer, an end of the corresponding carbon paste layer and an end of the corresponding silver paste layer. The package body has a first lateral surface, a second lateral surface opposite to the first lateral surface, and a bottom surface connected between the first lateral surface and the second lateral surface, the first exposed portion of the first conductive terminal is extended along the first lateral surface and the bottom surface of the package body, and the second exposed portion of the second conductive terminal is extended along the second lateral surface and the bottom surface of the package body.

Therefore, when the second conductive terminal has at least one through hole connected between the top surface and the bottom surface (or at least one through groove connected among the top surface, the bottom surface and the lateral surface), the conductive paste has a first conductive portion disposed between the bottommost first stacked-type capacitor and the top surface of the second conductive terminal and a second conductive portion filling in the at least one through hole (or the at least one through groove) to connect with the first conductive portion, thus the bonding strength between the first stacked-type capacitor and the second conductive terminal can be increased for preventing the first stacked-type capacitor from being separated from the second conductive terminal easily.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a lateral, schematic view of the capacitor unit of the solid electrolytic capacitor package structure according to the first embodiment of the instant disclosure;

FIG. 2A shows a top, schematic view of the first conductive unit of the solid electrolytic capacitor package structure according to the first embodiment of the instant disclosure;

FIG. 2B shows a top, schematic view of the second conductive unit of the solid electrolytic capacitor package structure according to the first embodiment of the instant disclosure;

FIG. 2C shows a top, schematic view of the third conductive unit of the solid electrolytic capacitor package structure according to the first embodiment of the instant disclosure;

FIG. 3 shows a top, schematic view of the capacitor unit disposed on the conductive unit according to the first embodiment of the instant disclosure;

FIG. 4 shows a lateral, schematic view of the solid electrolytic capacitor package structure for decreasing equivalent series resistance according to the first embodiment of the instant disclosure;

FIG. 5 shows an enlarged view taken on part A of FIG. 4;

FIG. 6 shows a flow chart of the method of manufacturing the solid electrolytic capacitor package structure for decreasing equivalent series resistance according to the first embodiment of the instant disclosure;

FIG. 7 shows a lateral, schematic view of the solid electrolytic capacitor package structure for decreasing equivalent series resistance according to the second embodiment of the instant disclosure;

FIG. 8 shows an enlarged view taken on part A of FIG. 7;

FIG. 9 shows a top, schematic view of the capacitor unit disposed on the conductive unit according to the third embodiment of the instant disclosure; and

FIG. 10 shows a lateral, schematic view of the solid electrolytic capacitor package structure for decreasing equivalent series resistance according to the third embodiment of the instant disclosure.

### DETAILED DESCRIPTION OF THE PREFERRED EMBODIMENTS

### First Embodiment

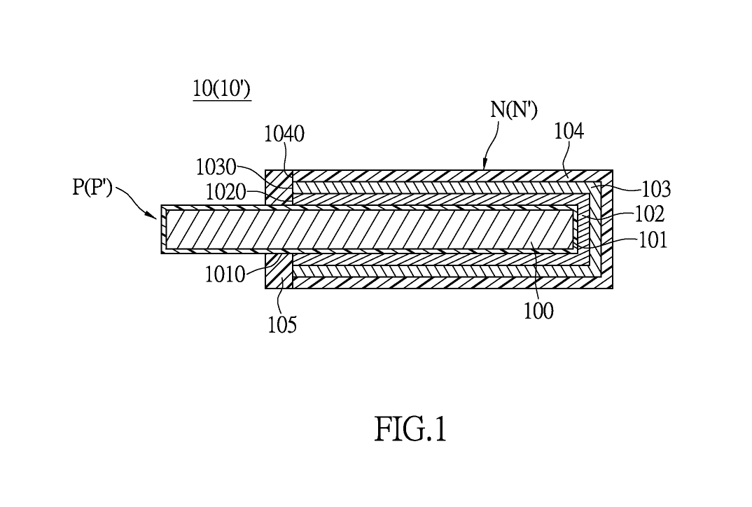

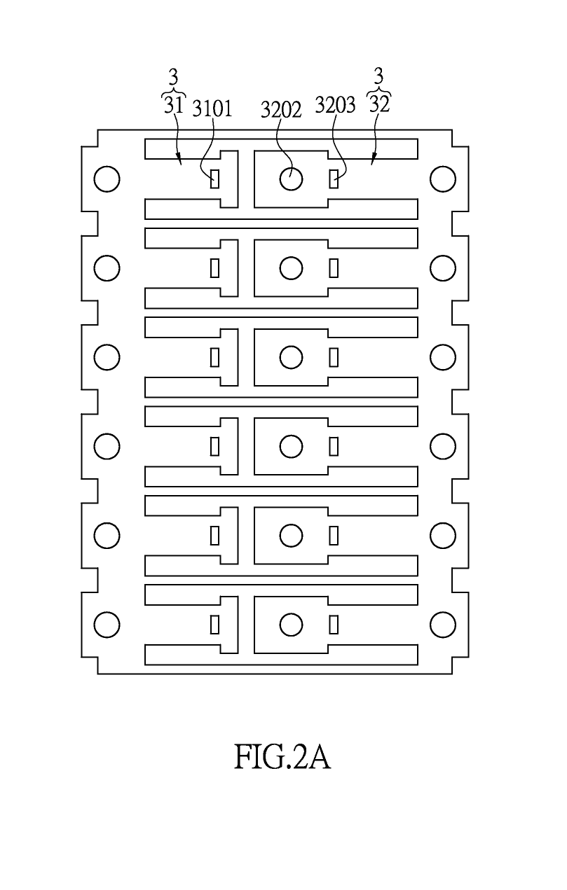

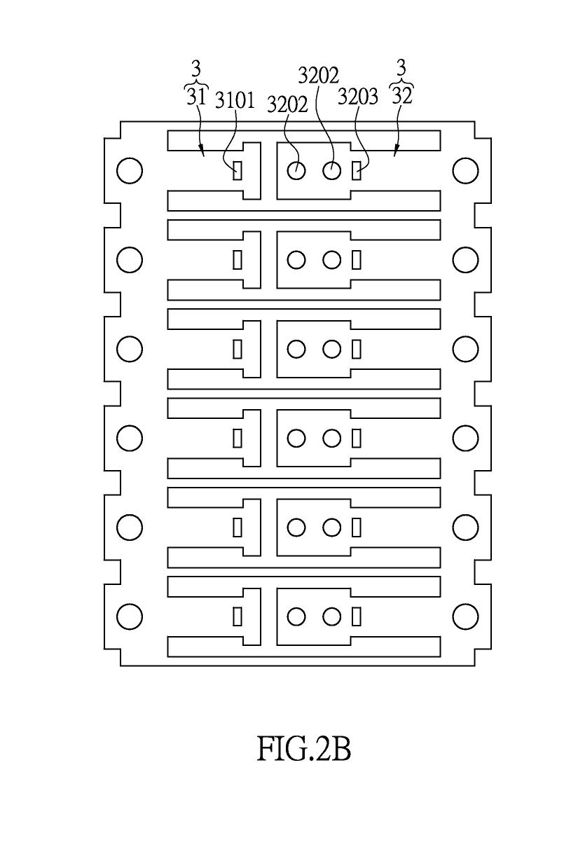

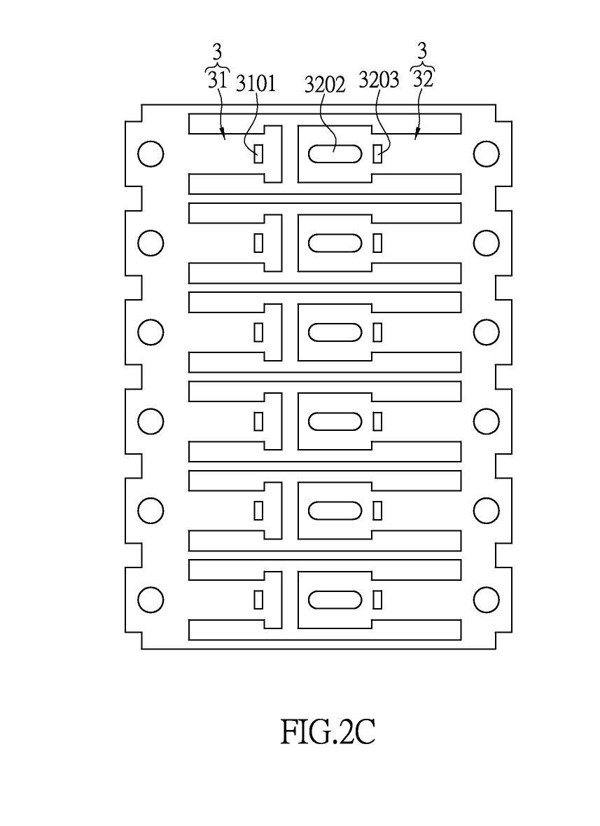

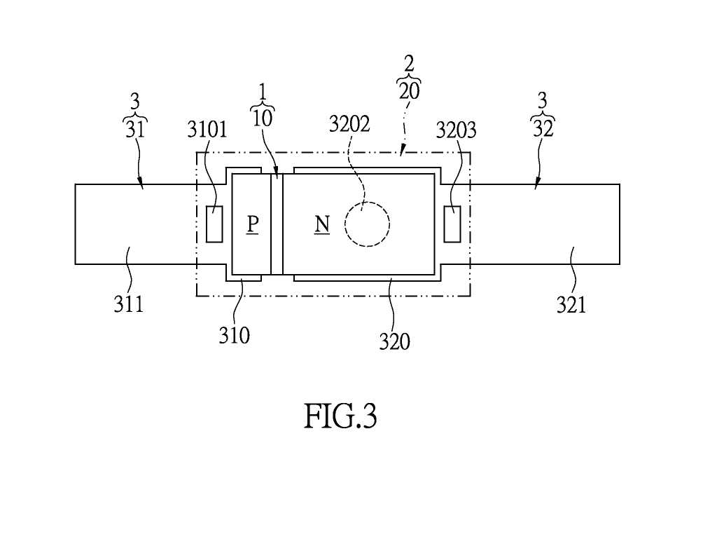

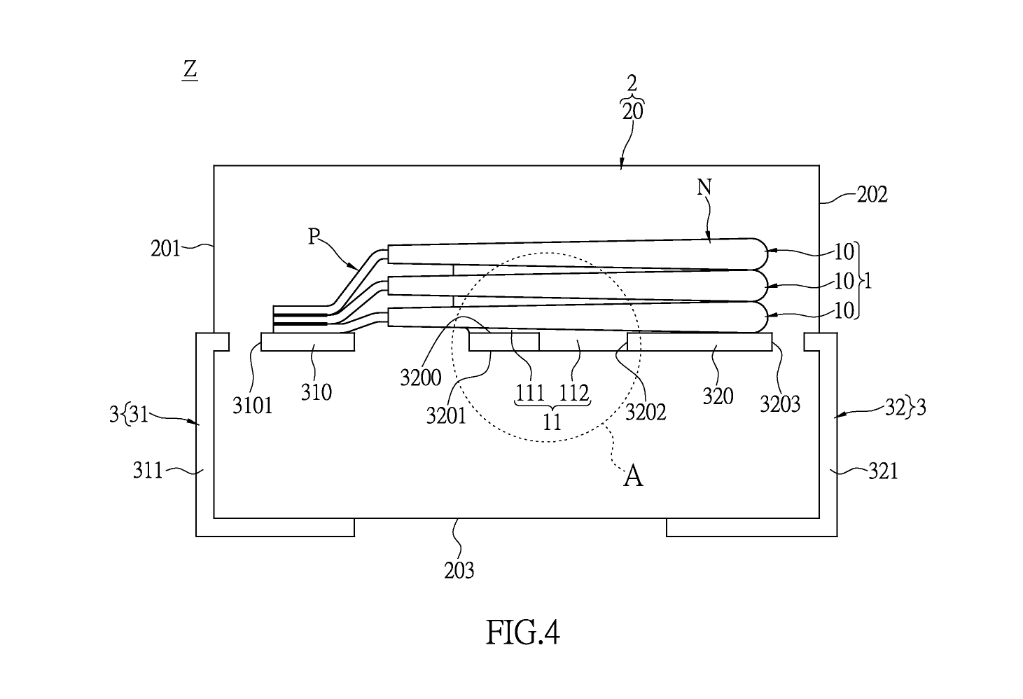

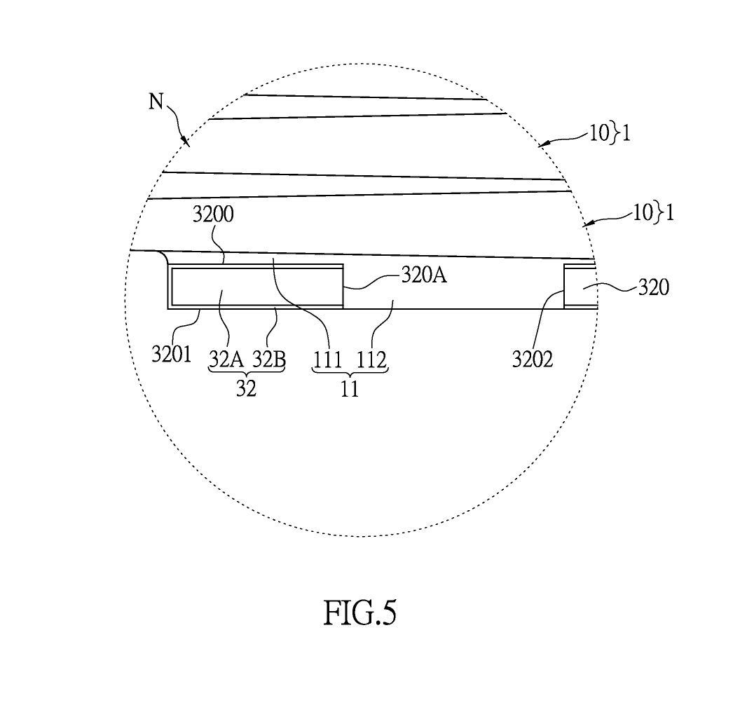

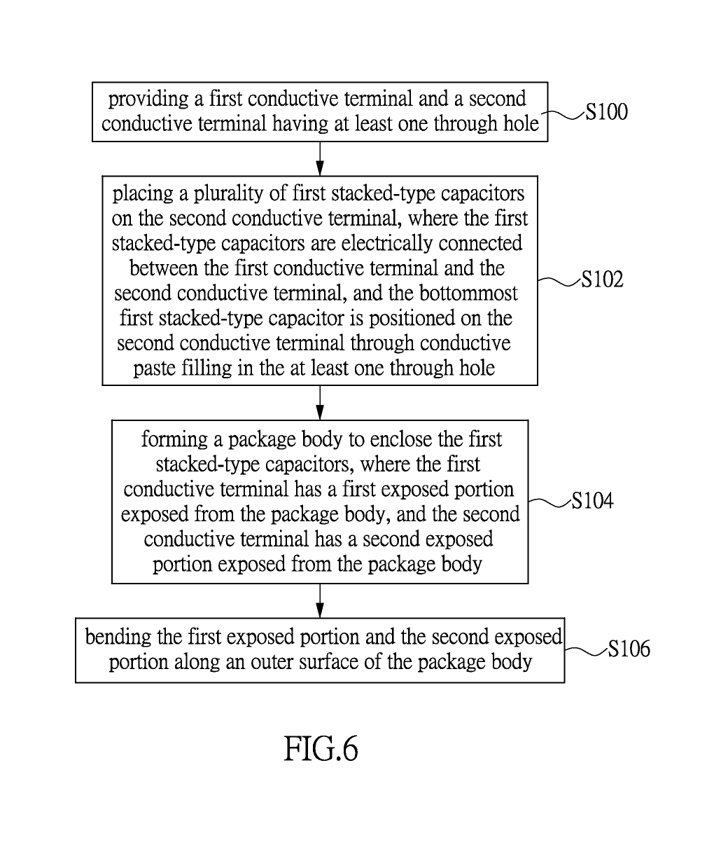

Referring to FIG. 1 to FIG. 6, FIG. 1 shows a lateral, schematic view of the capacitor unit of the solid electrolytic capacitor package structure, FIG. 2A shows a top, schematic view of the first conductive unit of the solid electrolytic capacitor package structure, FIG. 2B shows a top, schematic view of the second conductive unit of the solid electrolytic capacitor package structure, FIG. 2C shows a top, schematic view of the third conductive unit of the solid electrolytic capacitor package structure, FIG. 3 shows a top, schematic view of the capacitor unit disposed on the conductive unit, FIG. 4 shows a lateral, schematic view of the solid electrolytic capacitor package structure for decreasing equivalent series resistance, FIG. 5 shows an enlarged view taken on part A of FIG. 4, and FIG. 6 shows a flow chart of the method of manufacturing the solid electrolytic capacitor package structure for decreasing equivalent series resistance. The first embodiment of the instant disclosure provides a solid electrolytic capacitor package structure Z for decreasing equivalent series resistance (ESR), comprising: a capacitor unit 1, a package unit 2 and a conductive unit 3.

First, referring to FIG. 1, the capacitor unit 1 is provided with a plurality of first stacked-type capacitors 10 (i.e., chip-type capacitors), and each first stacked-type capacitor 10 has a first positive portion P and a first negative portion N. For example, each first stacked-type capacitor 10 includes a valve metal foil 100, an oxide insulation layer 101 enclosing the valve metal foil 100, a conductive polymer layer 102 covering one portion of the oxide insulation layer 101, a carbon paste layer 103 covering the conductive polymer layer 102, and a silver paste layer 104 covering the carbon paste layer 103. In addition, each first stacked-type capacitor 10 has a surrounding insulating layer 105 disposed on the outer surface of the oxide insulation layer 101 and around the outer surface of the oxide insulation layer 101, and the lengths of the conductive polymer layer 102, the carbon paste layer 103 and the silver paste layer 104 of each first stacked-type capacitor 10 are limited by the corresponding surrounding insulating layer 105. For more precisely, the oxide insulation layer 101 has a surrounding region 1010 on the outer surface thereof, and the surrounding insulating layer 105 of each first stacked-type capacitor 10 is surroundingly disposed on the surrounding region 1010 of the corresponding oxide insulation layer 101 and contacting an end 1020 of the corresponding conductive polymer layer 102, an end 1030 of the corresponding carbon paste layer 103 and an end 1040 of the corresponding silver paste layer 104. However, the above-mentioned design for the first stacked-type capacitors 10 of the first embodiment is merely an example and is not meant to limit the instant disclosure.

Moreover, referring to FIG. 2A, FIG. 3 and FIG. 4, the first stacked-type capacitors 10 are sequentially stacked on top of one another and electrically connected with each other, where the two first negative portions N of the two adjacent first stacked-type capacitors 10 are stacked on top of one another by silver paste (no label), and the two first positive portions P of the two adjacent first stacked-type capacitors 10 are stacked on top of one another by a soldering layer (no label). In addition, the package unit 2 includes a package body 20 for enclosing the capacitor unit 1, and the package body 20 may be an opaque material. Furthermore, the conductive unit 3 (i.e., a lead frame) includes a first conductive terminal 31 and a second conductive terminal 32 separated from the first conductive terminal 31. The first conductive terminal 31 has a first embedded portion 310 electrically connected to the first positive electrode portion P of the first stacked-type capacitor 10 (i.e., the first embedded portion 310 electrically contacts the first positive electrode portion P of the bottommost stacked-type capacitor 10) and enclosed by the package body 20 and a first exposed portion 311 connected with the first embedded portion 310 and exposed from the package body 20, and the second conductive terminal 32 has a second embedded portion 320 electrically connected to the first negative electrode portion N of the first stacked-type capacitor 10 (i.e., the second embedded portion 320 electrically contacts the first negative electrode portion N of the bottommost stacked-type capacitor 10) and enclosed by the package body 20 and a second exposed portion 321 connected with the second embedded portion 320 and exposed from the package body 20.

More precisely, referring to FIG. 3 and FIG. 4, the package body 20 has a first lateral surface 201, a second lateral surface 202 opposite to the first lateral surface 201, and a bottom surface 203 connected between the first lateral surface 201 and the second lateral surface 202. In addition, the first exposed portion 311 of the first conductive terminal 31 can be extended along the first lateral surface 201 and the bottom surface 203 of the package body 20 to form a first L-shaped bending pin, and the second exposed portion 321 of the second conductive terminal 32 can be extended along the second lateral surface 202 and the bottom surface 203 of the package body 20 to form a second L-shaped bending pin.

More precisely, referring to FIG. 2, FIG. 3 and FIG. 4, the second conductive terminal 32 has a top surface 3200, a bottom surface 3201 corresponding to the top surface 3200, and at least one through hole 3202 (or penetrating hole) connected between the top surface 3200 and the bottom surface 3201. The first negative electrode portion N of the bottommost first stacked-type capacitor 10 can be positioned on the top surface 3200 of the second conductive terminal 32 through conductive paste 11, and the conductive paste 11 has a first conductive portion 111 disposed between the bottommost first stacked-type capacitor 10 and the top surface 3200 of the second conductive terminal 32 and a second conductive portion 112 filling in the at least one through hole 3202 to integrally connect with the first conductive portion 111 (i.e., the at least one through hole 3202 can be filled with the second conductive portion 112 that is connected with the first conductive portion 111). In addition, the first conductive terminal 31 has at least one first penetrating filling hole 3101, the second conductive terminal 32 has at least one second penetrating filling hole 3203, and the at least one first penetrating filling hole 3101 and the at least one second penetrating filling hole 3203 can be filled with the package body 20. Thus, the bonding strength between the package body 20 and the first conductive terminal 31 (or the second conductive terminal 32) can be increased for preventing the package body 20 from being separated easily from the first conductive terminal 31 or the second conductive terminal 32.

For example, referring to FIG. 4 and FIG. 5, the second conductive terminal 32 includes a copper substrate 32A and a tin plating layer 32B covering the outer surface of the copper substrate 32A. In addition, the at least one through hole 3202 passes through the tin plating layer 32B and the copper substrate 32A, and the copper substrate 32A has a surrounding inner surface 320A formed in the at least one through hole 3202. The second conductive portion 112 of the conductive paste 11 can contact the surrounding inner surface 320A of the copper substrate 32A, and the conductive paste 11 may be silver paste or copper paste. More precisely, because the surrounding inner surface 320A of the copper substrate 32A can be exposed from the at least one through hole 3202 of the second conductive terminal 32, the second conductive portion 112 of the conductive paste 11 in the at least one through hole 3202 can contact the surrounding inner surface 320A of the copper substrate 32A for increasing the bonding strength between the first stacked-type capacitor 10 and the second conductive terminal 32. Hence, the design of the at least one through hole 3202 of the second conductive terminal 32 can be used to prevent the first stacked-type capacitor 10 from being separated easily from the second conductive terminal 32.

Furthermore, referring to FIG. 1 to FIG. 6, the first embodiment of the instant disclosure provides a method of manufacturing a solid electrolytic capacitor package structure Z for decreasing equivalent series resistance (ESR), comprising: referring to FIGS. 3, 4 and 6, providing a first conductive terminal 31 and a second conductive terminal 32 separated from the first conductive terminal 31, where the second conductive terminal 32 has a top surface 3200, a bottom surface 3201 corresponding to the top surface 3200, and at least one through hole 3202 connected between the top surface 3200 and the bottom surface 3201 (S100); referring to FIGS. 1, 4 and 6, placing a plurality of first stacked-type capacitors 10 on the top surface 3200 of the second conductive terminal 32, where the first stacked-type capacitors 10 are sequentially stacked on top of one another and electrically connected with each other, each first stacked-type capacitor 10 has a first positive electrode portion P and a first negative electrode portion N, the bottommost first stacked-type capacitor 10 is positioned on the top surface 3200 of the second conductive terminal 32 through conductive paste 11, and the conductive paste 11 has a first conductive portion 111 disposed between the bottommost first stacked-type capacitor 10 and the top surface 3200 of the second conductive terminal 32 and a second conductive portion 112 filling in the at least one through hole 3202 to integrally connect with the first conductive portion 111 (S102); referring to FIGS. 1, 4 and 6, forming a package body 20 to enclose the first stacked-type capacitors 10, where the first conductive terminal 31 has a first embedded portion 310 electrically connected to the first positive electrode portion P of the first stacked-type capacitor 10 and enclosed by the package body 20 and a first exposed portion 311 connected with the first embedded portion 310 and exposed from the package body 20, and the second conductive terminal 32 has a second embedded portion 320 electrically connected to the first negative electrode portion N of the first stacked-type capacitor 10 and enclosed by the package body 20 and a second exposed portion 321 connected with the second embedded portion 320 and exposed from the package body 20 (S104); and then bending the first exposed portion 311 and the second exposed portion 312 along an outer surface of the package body 20 (S106).

In addition, when the solid electrolytic capacitor package structure Z includes three first stacked-type capacitors 10 and each first stacked-type capacitor 10 has at least one through hole 3202, the ten solid electrolytic capacitor package structures Z from No. 1 to No. 10 are respectively tested to obtain ten different first ESR values (me) as shown in the following table. When the solid electrolytic capacitor package structure Z includes three first stacked-type capacitors 10 without using the through hole 3202, the ten solid electrolytic capacitor package structures Z from No. 1 to No. 10 are respectively tested to obtain ten different second ESR values (me) as shown in the following table.

| Serial Number | First ESR value (mΩ) | Second ESR value (mΩ) |
|---|---|---|
| No. 1 | 5.1 | 6.6 |
| No. 2 | 4.5 | 6.8 |
| No. 3 | 5.2 | 7.5 |
| No. 4 | 6.9 | 7.3 |
| No. 5 | 6.3 | 7.1 |
| No. 6 | 6.8 | 7.5 |
| No. 7 | 5.9 | 9.0 |
| No. 8 | 6.7 | 7.0 |
| No. 9 | 6.2 | 7.3 |
| No. 10 | 5.7 | 6.9 |
| Average Value | 5.4 | 7.3 |

More precisely, referring to FIG. 2B and FIG. 2C, each first stacked-type capacitor 10 has two or more than two through holes 3202 shown as circular through holes (as shown in FIG. 2B), or the through hole 3202 may be a long and narrow through hole (as shown in FIG. 2C). However, the above-mentioned design for the through hole 3202 of the first embodiment is merely an example and is not meant to limit the instant disclosure. For example, the through hole 3202 can be offset and may be shown as a triangular hole, a rectangular hole, a polygon hole or a petal-shaped hole etc.

### Second Embodiment

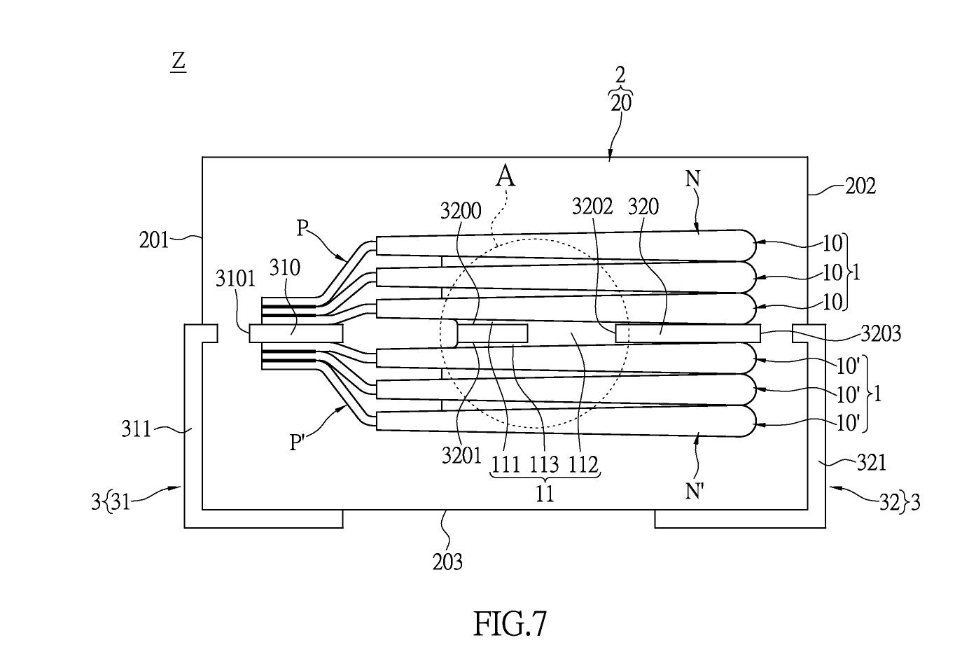

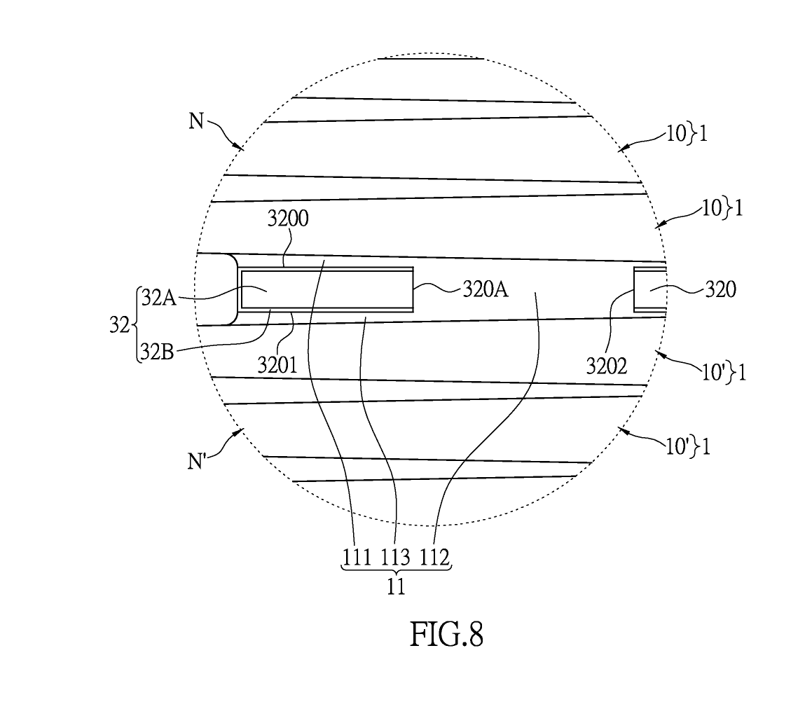

Referring to FIG. 7 and FIG. 8, FIG. 7 shows a lateral, schematic view of the solid electrolytic capacitor package structure for decreasing equivalent series resistance according to the second embodiment of the instant disclosure, and FIG. 8 shows an enlarged view taken on part A of FIG. 7. The second embodiment of the instant disclosure provides a solid electrolytic capacitor package structure Z for decreasing equivalent series resistance (ESR), comprising: a capacitor unit 1, a package unit 2 and a conductive unit 3. The difference between the second embodiment and the first embodiment is as follows: in the second embodiment, the capacitor unit 1 includes a plurality of second stacked-type capacitors 10′ sequentially stacked on top of one another and electrically connected with each other. In addition, each second stacked-type capacitor 10′ has a second positive electrode portion P′ and a second negative electrode portion N′, the bottommost second stacked-type capacitor 10′ can be positioned on the bottom surface 3201 of the second conductive terminal 32 through the conductive paste 11, and the conductive paste 11 has a third conductive portion 113 disposed between the bottommost second stacked-type capacitor 10′ and the bottom surface 3201 of the second conductive terminal 32 and connected with the second conductive portion 112.

Moreover, the second embodiment of the instant disclosure also can provide a method of manufacturing a solid electrolytic capacitor package structure Z for decreasing equivalent series resistance. The difference between the second embodiment and the first embodiment is as follows: the method of the second embodiment can further comprise: placing a plurality of second stacked-type capacitors 10′ on the bottom surface 3201 of the second conductive terminal 32 in the step S102 of the first embodiment as shown in FIG. 6, where the bottommost second stacked-type capacitor 10′ can be positioned on the bottom surface 3201 of the second conductive terminal 32 through the conductive paste 11, and the conductive paste 11 has a third conductive portion 113 disposed between the bottommost second stacked-type capacitor 10′ and the bottom surface 3201 of the second conductive terminal 32 and connected with the second conductive portion 112.

### Third Embodiment

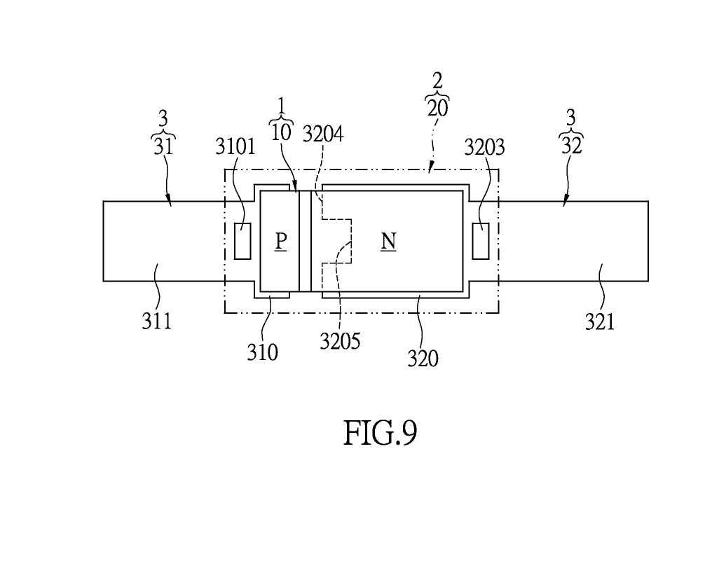

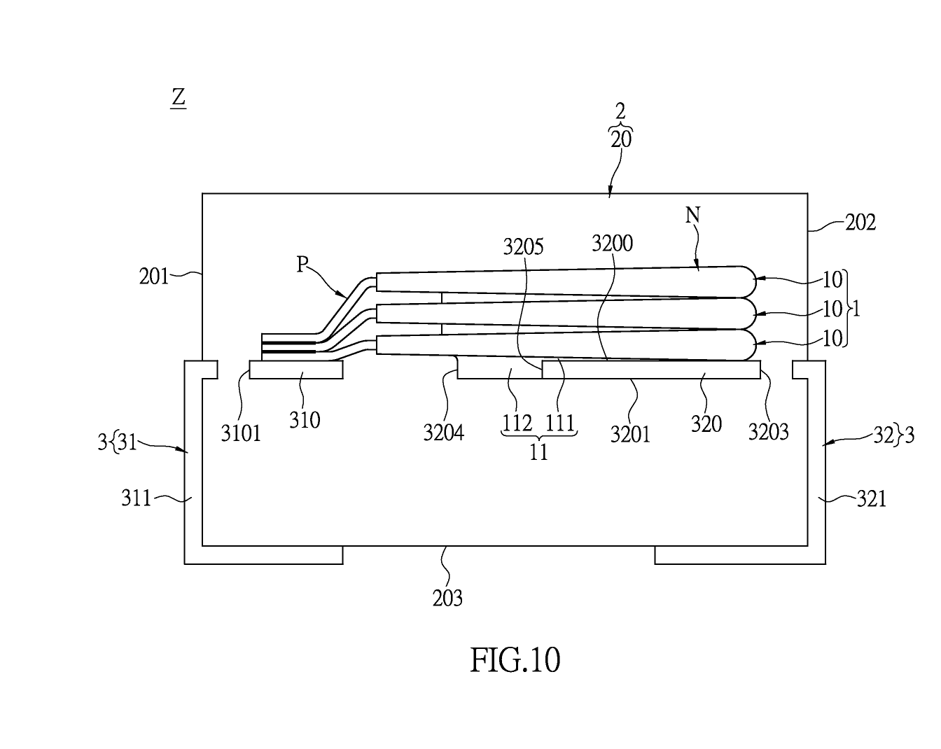

Referring to FIG. 9 and FIG. 10, FIG. 9 shows a top, schematic view of the capacitor unit disposed on the conductive unit according to the third embodiment of the instant disclosure, and FIG. 10 shows a lateral, schematic view of the solid electrolytic capacitor package structure for decreasing equivalent series resistance (ESR), according to the third embodiment of the instant disclosure. The third embodiment of the instant disclosure provides a solid electrolytic capacitor package structure Z for decreasing equivalent series resistance (ESR), comprising: a capacitor unit 1, a package unit 2 and a conductive unit 3. The difference between the third embodiment and the first embodiment is as follows: in the third embodiment, the second conductive terminal 32 has a top surface 3200, a bottom surface 3201 corresponding to the top surface 3200, a lateral surface 3204 connected between the top surface 3200 and the bottom surface 3201, and at least one through groove 3205 (or a penetrating slotting having a U-shaped cross section) connected among the top surface 3200, the bottom surface 3201 and the lateral surface 3204. The bottommost first stacked-type capacitor 10 can be positioned on the top surface 3200 of the second conductive terminal 32 through conductive paste 11, and the conductive paste 11 has a first conductive portion 111 disposed between the bottommost first stacked-type capacitor 10 and the top surface 3200 of the second conductive terminal 32 and a second conductive portion 112 filling in the at least one through groove 3205 to integrally connect with the first conductive portion 111. However, the above-mentioned design for the through groove 3205 of the third embodiment is merely an example and is not meant to limit the instant disclosure.

In conclusion, when the second conductive terminal 32 has at least one through hole 3202 connected between the top surface 3200 and the bottom surface 3201 (or at least one through groove 3205 connected among the top surface 3200, the bottom surface 3201 and the lateral surface 3204), the conductive paste 11 has a first conductive portion 111 disposed between the bottommost first stacked-type capacitor 10 and the top surface 3200 of the second conductive terminal 32 and a second conductive portion 112 filling in the at least one through hole 3201 (or the at least one through groove 3205) to connect with the first conductive portion 111, thus the bonding strength between the first stacked-type capacitor 10 and the second conductive terminal 32 can be increased for preventing the first stacked-type capacitor 10 from being separated from the second conductive terminal 32 easily.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A solid electrolytic capacitor package structure for decreasing equivalent series resistance, comprising:
a capacitor unit including a plurality of first stacked-type capacitors sequentially stacked on top of one another and electrically connected with each other, wherein each first stacked-type capacitor has a first positive electrode portion and a first negative electrode portion;
a package unit including a package body for enclosing the capacitor unit; and
a conductive unit including a first conductive terminal and a second conductive terminal separated from the first conductive terminal, wherein the first conductive terminal has a first embedded portion electrically connected to the first positive electrode portion of the first stacked-type capacitor and enclosed by the package body and a first exposed portion connected with the first embedded portion and exposed from the package body, and the second conductive terminal has a second embedded portion electrically connected to the first negative electrode portion of the first stacked-type capacitor and enclosed by the package body and a second exposed portion connected with the second embedded portion and exposed from the package body;
wherein the second conductive terminal has a top surface, a bottom surface corresponding to the top surface, and at least one through hole connected between the top surface and the bottom surface, the bottommost first stacked-type capacitor is positioned on the top surface of the second conductive terminal through conductive paste, and the conductive paste has a first conductive portion disposed between the bottommost first stacked-type capacitor and the top surface of the second conductive terminal and a second conductive portion filling in the at least one through hole to connect with the first conductive portion.

2. The solid electrolytic capacitor package structure of claim 1, wherein each first stacked-type capacitor includes a valve metal foil, an oxide insulation layer enclosing the valve metal foil, a conductive polymer layer covering one portion of the oxide insulation layer, a carbon paste layer covering the conductive polymer layer, and a silver paste layer covering the carbon paste layer, wherein each first stacked-type capacitor has a surrounding insulating layer disposed on the outer surface of the oxide insulation layer and around the outer surface of the oxide insulation layer, and the lengths of the conductive polymer layer, the carbon paste layer and the silver paste layer of each first stacked-type capacitor are limited by the corresponding surrounding insulating layer, wherein the oxide insulation layer has a surrounding region formed on the outer surface thereof, and the surrounding insulating layer of each first stacked-type capacitor is surroundingly disposed on the surrounding region of the corresponding oxide insulation layer and contacting an end of the corresponding conductive polymer layer, an end of the corresponding carbon paste layer and an end of the corresponding silver paste layer, wherein the package body has a first lateral surface, a second lateral surface opposite to the first lateral surface, and a bottom surface connected between the first lateral surface and the second lateral surface, the first exposed portion of the first conductive terminal is extended along the first lateral surface and the bottom surface of the package body, and the second exposed portion of the second conductive terminal is extended along the second lateral surface and the bottom surface of the package body.

3. The solid electrolytic capacitor package structure of claim 1, wherein the second conductive terminal includes a copper substrate and a tin plating layer covering the outer surface of the copper substrate, the at least one through hole passes through the tin plating layer and the copper substrate, the copper substrate has a surrounding inner surface in the at least one through hole, the second conductive portion of the conductive paste contacts the surrounding inner surface of the copper substrate, and the conductive paste is silver paste or copper paste.

4. The solid electrolytic capacitor package structure of claim 1, wherein the capacitor unit includes a plurality of second stacked-type capacitors sequentially stacked on top of one another and electrically connected with each other, each second stacked-type capacitor has a second positive electrode portion and a second negative electrode portion, the bottommost second stacked-type capacitor is positioned on the bottom surface of the second conductive terminal through the conductive paste, and the conductive paste has a third conductive portion disposed between the bottommost second stacked-type capacitor and the bottom surface of the second conductive terminal and connected with the second conductive portion.

5. The solid electrolytic capacitor package structure of claim 1, wherein the first conductive terminal has at least one first penetrating filling hole, the second conductive terminal has at least one second penetrating filling hole, and the at least one first penetrating filling hole and the at least one second penetrating filling hole are filled with the package body.

6. A solid electrolytic capacitor package structure for decreasing equivalent series resistance, comprising:
a capacitor unit including a plurality of first stacked-type capacitors sequentially stacked on top of one another and electrically connected with each other, wherein each first stacked-type capacitor has a first positive electrode portion and a first negative electrode portion;
a package unit including a package body for enclosing the capacitor unit; and
a conductive unit including a first conductive terminal and a second conductive terminal separated from the first conductive terminal, wherein the first conductive terminal has a first embedded portion electrically connected to the first positive electrode portion of the first stacked-type capacitor and enclosed by the package body and a first exposed portion connected with the first embedded portion and exposed from the package body, and the second conductive terminal has a second embedded portion electrically connected to the first negative electrode portion of the first stacked-type capacitor and enclosed by the package body and a second exposed portion connected with the second embedded portion and exposed from the package body;
wherein the second conductive terminal has a top surface, a bottom surface corresponding to the top surface, a lateral surface connected between the top surface and the bottom surface, and at least one through groove connected among the top surface, the bottom surface and the lateral surface, the bottommost first stacked-type capacitor is positioned on the top surface of the second conductive terminal through conductive paste, and the conductive paste has a first conductive portion disposed between the bottommost first stacked-type capacitor and the top surface of the second conductive terminal and a second conductive portion filling in the at least one through groove to connect with the first conductive portion.

7. The solid electrolytic capacitor package structure of claim 6, wherein each first stacked-type capacitor includes a valve metal foil, an oxide insulation layer enclosing the valve metal foil, a conductive polymer layer covering one portion of the oxide insulation layer, a carbon paste layer covering the conductive polymer layer, and a silver paste layer covering the carbon paste layer, wherein each first stacked-type capacitor has a surrounding insulating layer disposed on the outer surface of the oxide insulation layer and around the outer surface of the oxide insulation layer, and the lengths of the conductive polymer layer, the carbon paste layer and the silver paste layer of each first stacked-type capacitor are limited by the corresponding surrounding insulating layer, wherein the oxide insulation layer has a surrounding region formed on the outer surface thereof, and the surrounding insulating layer of each first stacked-type capacitor is surroundingly disposed on the surrounding region of the corresponding oxide insulation layer and contacting an end of the corresponding conductive polymer layer, an end of the corresponding carbon paste layer and an end of the corresponding silver paste layer, wherein the package body has a first lateral surface, a second lateral surface opposite to the first lateral surface, and a bottom surface connected between the first lateral surface and the second lateral surface, the first exposed portion of the first conductive terminal is extended along the first lateral surface and the bottom surface of the package body, and the second exposed portion of the second conductive terminal is extended along the second lateral surface and the bottom surface of the package body.

8. The solid electrolytic capacitor package structure of claim 6, wherein the capacitor unit includes a plurality of second stacked-type capacitors sequentially stacked on top of one another and electrically connected with each other, each second stacked-type capacitor has a second positive electrode portion and a second negative electrode portion, the bottommost second stacked-type capacitor is positioned on the bottom surface of the second conductive terminal through the conductive paste, and the conductive paste has a third conductive portion disposed between the bottommost second stacked-type capacitor and the bottom surface of the second conductive terminal and connected with the second conductive portion.

9. The solid electrolytic capacitor package structure of claim 6, wherein the first conductive terminal has at least one first penetrating filling hole, the second conductive terminal has at least one second penetrating filling hole, and the at least one first penetrating filling hole and the at least one second penetrating filling hole are filled with the package body.

10. A method of manufacturing a solid electrolytic capacitor package structure for decreasing equivalent series resistance, comprising:
providing a first conductive terminal and a second conductive terminal separated from the first conductive terminal, wherein the second conductive terminal has a top surface, a bottom surface corresponding to the top surface, and at least one through hole connected between the top surface and the bottom surface;
placing a plurality of first stacked-type capacitors on the top surface of the second conductive terminal, wherein the first stacked-type capacitors are sequentially stacked on top of one another and electrically connected with each other, each first stacked-type capacitor has a first positive electrode portion and a first negative electrode portion, the bottommost first stacked-type capacitor is positioned on the top surface of the second conductive terminal through conductive paste, and the conductive paste has a first conductive portion disposed between the bottommost first stacked-type capacitor and the top surface of the second conductive terminal and a second conductive portion filling in the at least one through hole to connect with the first conductive portion;
forming a package body to enclose the first stacked-type capacitors, wherein the first conductive terminal has a first embedded portion electrically connected to the first positive electrode portion of the first stacked-type capacitor and enclosed by the package body and a first exposed portion connected with the first embedded portion and exposed from the package body, and the second conductive terminal has a second embedded portion electrically connected to the first negative electrode portion of the first stacked-type capacitor and enclosed by the package body and a second exposed portion connected with the second embedded portion and exposed from the package body; and
bending the first exposed portion and the second exposed portion along an outer surface of the package body.

11. The method of claim 10, wherein each first stacked-type capacitor includes a valve metal foil, an oxide insulation layer enclosing the valve metal foil, a conductive polymer layer covering one portion of the oxide insulation layer, a carbon paste layer covering the conductive polymer layer, and a silver paste layer covering the carbon paste layer, wherein each first stacked-type capacitor has a surrounding insulating layer disposed on the outer surface of the oxide insulation layer and around the outer surface of the oxide insulation layer, and the lengths of the conductive polymer layer, the carbon paste layer and the silver paste layer of each first stacked-type capacitor are limited by the corresponding surrounding insulating layer, wherein the oxide insulation layer has a surrounding region formed on the outer surface thereof, and the surrounding insulating layer of each first stacked-type capacitor is surroundingly disposed on the surrounding region of the corresponding oxide insulation layer and contacting an end of the corresponding conductive polymer layer, an end of the corresponding carbon paste layer and an end of the corresponding silver paste layer, wherein the package body has a first lateral surface, a second lateral surface opposite to the first lateral surface, and a bottom surface connected between the first lateral surface and the second lateral surface, the first exposed portion of the first conductive terminal is extended along the first lateral surface and the bottom surface of the package body, and the second exposed portion of the second conductive terminal is extended along the second lateral surface and the bottom surface of the package body.

12. The method of claim 10, wherein the second conductive terminal includes a copper substrate and a tin plating layer covering the outer surface of the copper substrate, the at least one through hole passes through the tin plating layer and the copper substrate, the copper substrate has a surrounding inner surface in the at least one through hole, the second conductive portion of the conductive paste contacts the surrounding inner surface of the copper substrate, and the conductive paste is silver paste or copper paste.

13. The method of claim 10, wherein the step of placing a plurality of second stacked-type capacitors on the top surface of the second conductive terminal further comprises: placing a plurality of second stacked-type capacitors on the bottom surface of the second conductive terminal, wherein the second stacked-type capacitors are sequentially stacked on top of one another and electrically connected with each other, each second stacked-type capacitor has a second positive electrode portion and a second negative electrode portion, the bottommost second stacked-type capacitor is positioned on the bottom surface of the second conductive terminal through the conductive paste, and the conductive paste has a third conductive portion disposed between the bottommost second stacked-type capacitor and the bottom surface of the second conductive terminal and connected with the second conductive portion.

14. The method of claim 10, wherein the first conductive terminal has at least one first penetrating filling hole, the second conductive terminal has at least one second penetrating filling hole, and the at least one first penetrating filling hole and the at least one second penetrating filling hole are filled with the package body.
